(19) United States
(12) Patent Application Publication
(10) Pub. No.: US 2024/0335965 A1
(43) Pub. Date: Oct. 10, 2024

(54) GRAY HAIR REMOVAL CUTTER, GRAY HAIR REMOVAL COMPONENT, GRAY HAIR REMOVAL COMB, AND GRAY HAIR REMOVAL SYSTEM

(71) Applicants: Jian-Bin BAO, Edmonton, Alberta (CA); Nicholas Pingtao BAO, Edmonton, Alberta (CA)

(72) Inventors: Jian-Bin BAO, Edmonton, Alberta (CA); Nicholas Pingtao BAO, Edmonton, Alberta (CA)

(21) Appl. No.: 18/293,984

(22) PCT Filed: Jul. 27, 2022
(86) PCT No.: PCT/CN2022/108080

§ 371 Date: Jan. 31, 2024

(30) Foreign Application Priority Data
Aug. 2, 2021 (CN) 202110881902.0

(51) Int. Cl. B26B 19/38

(52) U.S. Cl. CPC B26B 19/388; B26B 19/3846

(57) ABSTRACT

A gray hair removal cutter, a gray hair removal component, a gray hair removal comb, and a gray hair removal system are disclosed. The gray hair removal cutter includes a handle and a blade located on the handle. The extension direction of the handle is defined as the first direction, the direction perpendicular to the first direction as the second direction, and the direction perpendicular to both the first and second directions as the third direction. The single edge or two opposite edges of the blade include a cutting edge that is used for removing gray hair along the third direction, and the cutting edge extends along the second direction. The gray hair removal cutter does not require housing, and the position of the blade is closer to the scalp, allowing for the complete cutting of gray hair at the root.

### FIELD OF THE INVENTION

This invention relates to the field of hair dressing technology. More specifically, it pertains to a gray hair removal cutter, gray hair removal component, gray hair removal comb, and gray hair removal system.

### BACKGROUND OF THE INVENTION

As people reach middle age, their hair tends to turn gray. Particularly during this stage, which is often a period of career advancement, premature graying can impact one's personal image. Gray hair (or white hair) during this period has its characteristics: it is not highly prevalent and may appear sparse. Given the limited quantity, dyeing would not be worthwhile and would have side effects, A simple and effective method is to directly cut away the gray hair, but cutting gray hair is not easy.

One common method for cutting gray hair is to use a cutter to directly sever the gray hair. Traditional gray hair cutters typically require a protective housing. However, due to their small size, the relative movement between the cutter and the housing can easily be obstructed by dandruff, hair, and other factors, making it difficult to achieve the desired cut ting motion. Moreover, the cost of the manufacture and maintenance of such devices is high.

Therefore, to overcome the technical shortcomings existing in the current technology, there is a need to provide a new gray hair removal cutter, gray hair removal component, gray hair removal comb, and gray hair removal system.

### SUMMARY OF THE INVENTION

The purpose of the present invention is to provide a gray hair removal cutter, gray hair removal component, gray hair removal comb, and gray hair removal system to solve at least one of the problems existing in the current technology.

To achieve at least one of the above objectives, the present invention adopts the following technical solution:

In the first aspect of the present invention, a gray hair removal cutter is provided, comprising:
a handle and a blade located on the handle;
defining that the extension direction of the handle is the first direction, the direction perpendicular to the first direction is the second direction, and the direction perpendicular to both the first and second directions is the third direction;
wherein the single edge or two opposite edges of the blade comprise a cutting edge that is used for removing gray hair along the third direction, and the cutting edge extends along the second direction.

Optionally, the blade is formed by extending outward from a side wall of the handle along the second direction.

Optionally, the end of the blade away from the handle forms a cone or blunt cone.

Optionally, the two opposite sides of the blade arranged along the third direction incline inward and form a curved surface that is recessed inward in the middle:
the cutting edge is formed on at least one edge of the curved surface.

Optionally, the handle comprises an extended segment that is formed by extending from a side wall of the handle along the second direction, and the blade is located at the end of the extended segment that is away from the handle;
the cross-sections of the extended segment and the blade in the third direction are conical or parabolic.

Optionally, the handle comprises a main body and an extended portion that is formed by extending from one end of the main body along the first direction, and the thickness of the extended portion is less than the thickness of the main body;
the extended portion and the main body form an unoccupied portion therebetween, and the blade is located at the site of the unoccupied portion;
the blade is formed by extending from the extended portion towards the unoccupied portion;
the cutting edge is formed on either a single edge or two opposite edges of the end of the blade that is away from the main body.

Optionally, the cutter further comprises an identification unit, a sensing unit, and a driving unit set in the handle;
the sensing unit responds to the contact of the end of the handle and the scalp, and outputs a start signal;
the identification unit responds to the start, signal, identifies gray hair, and outputs a removal signal;

based on the removal signal, the driving unit drives the blade to move, causing the cutting edge to remove the identified gray hair.

Optionally, the driving unit is at least one of an electrostatic actuator, an electromagnetic actuator, a piezoelectric actuator, or a reverse piezoelectric actuator.

Preferably, the height between the blade and the bottom end of the handle in the first direction is not greater than 10 mm.

Preferably, the length of the cutting edge of the blade in the second direction is in the range of 10 μm to 10 mm; more preferably, the length of the cutting edge is in the range of 90 μm to 3 mm.

Preferably, the width of the blade in the third direction is not greater than the width of the handle in the third direction, and both widths are not greater than 10 mm.

In the second aspect of the invention, a gray hair removal component is provided, comprising at least one gray hair removal cutter as provided in the first aspect of the invention.

In the third aspect of the invention, a gray hair removal component is provided, comprising:
a first gray hair removal cutter and a second gray hair removal cutter as provided in the first aspect of the invention, arranged opposite each other;
the cutting edge of the first gray hair removal cutter and the cutting edge of the second gray hair removal cutter are arranged opposite each other;
the first gray hair removal cutter and the second gray hair removal cutter can approach each other along the third direction to cut gray hair.

Optionally, the blade of the first gray hair removal cutter and the blade of the second gray hair removal cutter are formed by extending outward from their respective handle side walls along the second direction;
the blade of the first gray hair removal cutter and the blade of the second gray hair removal cutter are centrosymmetrically arranged; and
the cutting edges are formed on the edge of the blade of the first gray hair removal cutter that is opposite to the blade of the second gray hair removal cutter, and/or on the edge of the blade of the second gray hair removal cutter that is opposite to the blade of the first gray hair removal cutter.

Optionally, the handle of the second gray hair removal cutter comprises a main body and an extended portion that is formed by extending, from one end of the main body along the first direction, and the thickness of the extended portion is less than the thickness of the main body;
the extended portion and the main body form an unoccupied portion therebetween, and the blade of the second gray hair removal cutter is located at the site of the unoccupied portion;
the blade of the second gray hair removal cutter is formed by extending from the extended portion towards the unoccupied portion;
the cutting edge of the second gray hair removal cutter is formed on the bottom edge of the blade of the second gray hair removal cutter that is opposite to the blade of the first gray hair removal cutter.

Optionally, the blade of the first gray hair removal cutter is formed by extending outward from one side wall of the handle along the third direction
the bottom surface of the blade of the first gray hair removal cutter and the cutting edge of the second gray hair removal cutter are arranged opposite each other.

Optionally, the blade of the first gray hair removal cutter is formed by extending outward from one side wall of the handle along the second direction;
the top surface of the blade of the first gray hair removal cutler and the cutting edge of the second gray hair removal cutter are arranged opposite each other.

Preferably, the distance in the third direction between the cutting edge of the first gray hair removal cutter and the second gray hair removal cutter is in the range of 10 μm to 10 mm; more preferably, the distance is in the range of 90 μm to 3 mm.

In the fourth aspect of the invention, a gray hair removal comb is provided, comprising a comb body and at least one gray hair removal component as provided in the second aspect of the invention.

In the fifth aspect of the invention, a gray hair removal comb is provided, comprising a comb body and at least one gray hair removal component as provided in the third aspect of the invention.

In the sixth aspect of the invention, a gray hair removal system is provided, comprising a gray hair removal comb as provided in the fourth aspect of the invention or a gray hair removal comb as provided in the fifth aspect, of the invention.

Optionally, the system comprises a recording module for recording and storing the real-time length of each gray hair of the user.

The beneficial effects of the present invention are as follows:

To address the technical problems existing in the prior technologies, the embodiments of the present invention provide a gray hair removal cutter, a Pray hair removal component, a gray hair removal comb, and a gray hair removal system. The gray hair removal cutter in the implementation does not require housing, and the posit ion of the blade is closer to the scalp, allowing for the complete cut of gray hair at the root. This achieves the goal of removing gray hair while preserving colored hair, enhancing the user's personal image, and extending the image of a full head of colored hair for at least ten years or more.

### BRIEF DESCRIPTION OF THE DRAWINGS

Below is a further detailed description of specific implementations of the present invention, in conjunction with the accompanying drawings.

FIGS. 1a-1c show three views of the structure of a gray hair removal cutter in an embodiment of the present invention.

FIG. 2 shows a top view of the structure of the blade in an embodiment of the present invention.

FIGS. 3a-3c show three views of the structure of another gray hair removal cutter in an embodiment of the present invention.

FIGS. 4a-4c show three views of the structure of another gray hair removal cutter in an embodiment of the present invention.

FIG. 5 shows a schematic view of the structure of a gray hair removal cutter comprising the identification unit and the sensing unit in an embodiment of the present invention.

FIG. 6 shows a top view of the structure of a gray hair removal cutter comprising the identification unit in an embodiment of the present invention.

FIG. 7 shows a schematic diagram of the operation of the driving units driving the blades and cutting, edges in an embodiment of the present invention.

FIG. 8 shows a top view of the structure of a gray hair removal cutter comprising multiple identification units in an embodiment of the present invention.

FIGS. 9a-9b show a front view and a top view of the structure of a gray hair removal component in an embodiment of the present invention.

FIGS. 10a-10c show three views of the structure of a gray hair removal component in an embodiment of the present invention.

FIGS. 11a-l c show three views of the structure of another gray hair removal component in an embodiment of the present invention.

FIG. 12 shows a schematic diagram of the structure of a gray hair removal comb in an embodiment of the present invention.

FIG. 13 shows a schematic diagram of the structure of another gray hair removal comb in an embodiment of the present invention.

FIG. 14 shows a schematic diagram of the structure of a gray hair removal system in an embodiment of the present invention.

### DETAILED DESCRIPTION OF THE INVENTION

In the following description, for illustrative purposes, many specific details are presented to provide a comprehensive understanding of one or more implementations. However, it is apparent that these implementations can be realized without these specific details.

In the description of the present invention, it should be noted that terms such as “up,” “down,” and the like indicating directional or positional relationships are based on the directional or positional relationships shown in the figures. These terms are used solely for the convenience of describing the present invention and simplifying the description. They do not indicate or imply that the devices or elements referred to must have a specific direction or be constructed and operated in a specific direction. Therefore, they should not be understood as the limits of the present invention. Unless otherwise explicitly specified or limited, terms such as “connect,” and “connection” should be broadly interpreted.

For example, it may be a fixed connection or a detachable connection, or an integral connection; it may be a mechanical connection or an electrical connection; it may be a direct connection or an indirect connection through an intermediate medium, and it may be a connection within two elements. For those skilled in the art, the specific meanings of these terms in the context of the present invention can be understood according to specific circumstances.

It should also be noted that, in the description of the present invention, relational terms such as “first” and “second” are used solely to distinguish one entity or operation from another, and do not necessarily imply any actual relation or order between these entities or operations. Furthermore, terms such as “comprise,” “include,” or any other variations thereof, are intended to encompass non-exclusive inclusion, so that processes, methods, items, or devices comprising a series of elements include not only those elements explicitly listed, but also other elements not explicitly listed, or the elements that are inherent to such processes, methods, items, or devices. Unless further restricted, the elements limited by the statement “comprising a . . . ” do not exclude the presence of other identical elements in the processes, methods, items, or devices that include the specified elements.

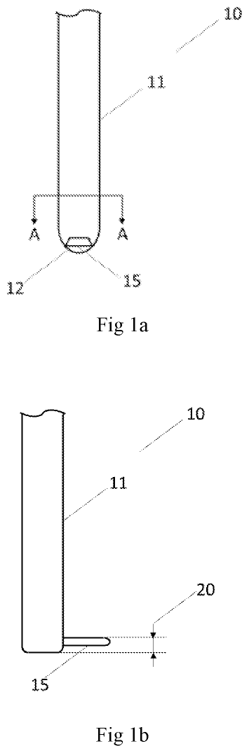

To address the issues in existing technologies, as shown in FIGS. 1-8, an embodiment of the present invention provides a gray hair removal cutter, comprising a handle and a blade located on the handle. The extension direction of the handle is defined as the first direction, the direction perpendicular to the first direction as the second direction, and the direction perpendicular to both the first and second directions as the third direction. The single edge or two opposite edges of the blade comprise a cutting edge for removing gray hair along the third direction, and the cutting edge extends along the second direction. That is, one edge or both opposite edges of the blade extending along the second direction are sharpened, forming the cutting edges.

Specifically, the cutting edge may be a straight or curved line for cutting gray hair, and the surface where the cutting edge is located is the cutting surface. Depending on the specific situation, the cutting surface may be the upper or lower surface of the blade. In a specific example, the cutting edge may be an edge of a metal piece, another rigid inorganic material piece, a rigid organic material piece (including a polymer material piece), or a rigid composite material piece located on the blade. In another specific example, the cutting edge may be formed by thinning one edge or both opposite edges of the blade.

In a specific example, the handle 11 extends' in the vertical direction, as shown in FIG. 1. The first direction is the vertical direction or the height direction of the handle 11. The second direction, perpendicular to the first direction, is the front-back direction or its length direction (i.e., the direction that is perpendicular to the plane of FIG. 1a), and the size of the handle along this direction is called the thickness. The third direction is the left-right direction or its width direction. The left-right direction is perpendicular to the front-back direction. II this specific example, the gray hair removal cutter 10 scans or moves along the second direction (the front-back direction) or a direction close to it on the surface of the user's scalp. The cutting edge moves along the left-right direction for cutting gray hair.

In a specific example, the blade 15 is positioned near the bottom end of the handle 11, and in the vertical direction, the height 20 from the blade 15 to the bottom end 12 of the handle 11 is not greater than 10 mm. In another specific example, the width 21 of the blade 15 in the third direction, i.e., the left-right direction, is not greater than the width 23 of the handle 11 in the left-right direction, and both the widths of the blade 15 and the handle 11 in the left-right direction are not greater than 10 mm.

In a specific example, the blade 15 is not sharpened in the second direction, i.e., the front-back direction. That is, the side edge of the blade 15 extending along the third direction (the left-right direction) does not form a cutting edge and does not have cutting ability. Instead, one edge or both opposite edges (edges 16 or 17) extending along the second direction are sharpened, forming the cutting edges and providing cutting ability. In other words, gray hair is not cut along the moving direction (the front-back direction) of the gray hair removal cutter 10. Instead, the cutting edges move along the left-right direction to cut gray hair on the left and right.

In a specific example, the length 22 of the cutting edge in the second direction is in the range of 10 μm to 10 mm. In a preferred example, the length 22 of the cutting edge is in the range of 90 μm to 3 mm.

The gray hair removal cutter 10 in this implementation does not require housing, and the position of the blade is closer to the scalp, allowing for a complete cut of gray hair at the root. This achieves the goal of removing gray hair while preserving colored hair, enhancing the user's personal image, and extending the image of a full head of colored hair for at least ten years or more.

In a possible implementation, as shown in FIGS. 1a-l e, the blade 15 extends outward from one side wall of the handle 11 along the second direction. For example, the blade 15 is located on the back side of the handle 11. When it moves along the second direction on the surface of the user's scalp, the gray hair removal cutter 10 separates the hair to the left and right, preventing it from being covered. This Facilitates the cutting of gray hair along the left-right direction by the blade 15 on the back side. In a specific example, the bottom end 12 of the handle 11 is a cone or blunt cone. That is, the cross-section of the bottom end 12 of the handle 11 in the third direction (the left-right direction) is approximately conical or parabolic. The cross-section of the bottom end 12 of the handle 11 in the second direction (the front-back direction) is conical or parabolic. Therefore, as it moves, the gray hair removal cutter 10 separates hairs further to the left and right, avoiding any hair gathering in front of the gray hair removal cutter, and ensuring that the cutting edge operates on all hairs.

In a specific example, both opposite edges of the blade 15 extending along the second direction (i.e., edges 16 or 17) are unsharpened, or both opposite edges (i.e., edges 16 or 17) are made of soft material. In this case, the blade is blunt, and a blunt blade can be used in conjunction with the cutting edge on the blade of another gray hair removal cutter, thereby minimizing damage to colored hair.

In a specific example, the blade 15 and the handle 11 may be made of the same material, by locally modifying the hardness or other material properties of the edges 16 or 17. In terms of function, the blade 15 can be either sharpened, or unsharpened (i.e., blunted).

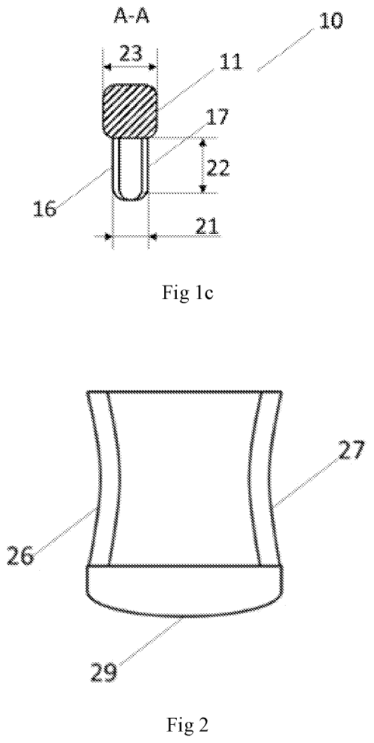

In a possible implementation, the end 29 of the blade away from the handle forms a cone or blunt cone. That is, as shown in FIG. 2, the cross-section of the end 29 of the blade away from the handle in the second direction is conical or parabolic. This allows only the cutting edges 26 and 27 on the opposite edges of the blade to cut gray hair during use. The width of the blade in the left-right direction is not greater than the width of the cone or blunt cone 29 in the left-right direction, preventing accidental damage to colored hair during use.

In a possible implementation, as shown in FIG. 2, the two opposite sides of the blade along the third direction incline inward and form a curved surface with a concave middle. The cutting edge is formed on at least one edge of the curved surface, i.e., the left and right bottom edges 26 and 27 of the blade, meaning that the cutting edge is arc-shaped. By setting arc-shaped cutting edges, gray hair can be guided to the middle of the cutting edges (i.e., the concave portion) during the movement of the cutting edges along the third direction, preventing gray hair from slipping away and thereby improving the success rate of cutting gray hair. Those skilled in the art understand that the shape of the cutting edges can also be other shapes that prevent gray hair from slipping.

In a specific example, both opposite edges of the two curved surfaces extending along the second direction of the blade (i.e., the left and right bottom edges 26 and 27 of the blade) are unsharpened, or both opposite edges (i.e., the left and right bottom edges 26 and 27 of the blade) are made of soft material. In this case, the blade is blunt, and a blunt blade can be used in conjunction with the cutting edge on the blade of another gray hair removal cutter.

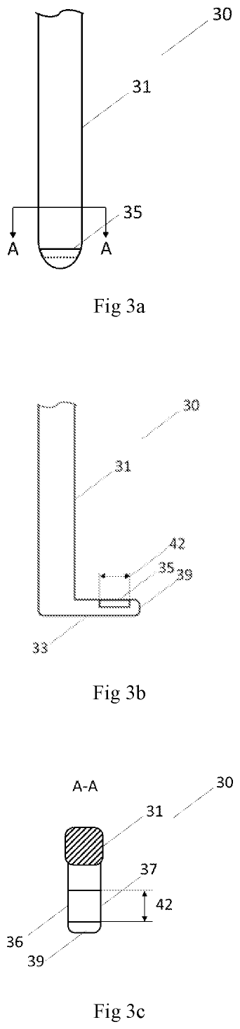

In a possible implementation, as shown in FIGS. 3a-3c, the handle 31 comprises an extended segment 33 extending from one side wall along the second direction, and the blade 35 is located at the end of the extended segment 33 away from the handle 31. The cross-section of the extended segment 33 and the blade 35 in the third direction is conical or parabolic. That is, the lower part of the extended segment 33 and the blade 35 forms a blunt cone. In this implementation, compared to the example shown in FIG. 1, by setting the extended segment 33, the length between the blade 35 and the handle 31 can be increased, and the length of the cutting edge of the blade 35 can also be increased. For example, the length 42 of the cutting edge is in the range of 10 μm to 10 mm. This implementation ensures that the hair is separated to the left and right sides of the gray hair removal cutter 30. In a specific example, the end of the blade 35 away from the extended segment 33 forms a cone or blunt cone 39. That is, the cross-section of the end of the blade 35 in the second direction is conical or parabolic. In a preferred example, the blade 35 and the cone 39 are integrally formed. By the cooperation of the cone or blunt cone beneath the extended segment 33 and the blade 35, and the cone or blunt cone 39 at the end away from the extended segment 33, this implementation separates the hair to the left and right sides of the gray hair removal cutter 30. The hair cutting is not performed in the front-back direction. The cutting is performed by the cutting edges of the left and/or right edges 36 and 37 of the blade 35. Moreover, the width of the blade 35 in the left-right direction is controlled not to exceed the width of the handle 31 or the cone or blunt cone 39, and the width of the blade 35 is even controlled not to exceed the width of the extended segment 33. In this implementation, the blade 35 is protected in the front, back, left, and right directions by the handle 31 and the cone or blunt cone 39 during the combing of hair, avoiding accidental damage to colored hair.

In a specific example, both opposite edges (i.e., edges 36 and 3⁷) of the blade extending along the second direction are unsharpened, or both opposite edges (i.e., edges 36 and 37) are made of soft material. In this case, the blade is blunt, and a blunt blade can be used in conjunction with the cutting edge on the blade of another gray hair removal cutter. In a specific example, the gray hair removal cutter does not need to have a blade 35. The space originally occupied by the blade is replaced by the material of the handle, thus the gray hair removal cutter is also a blunt cutter.

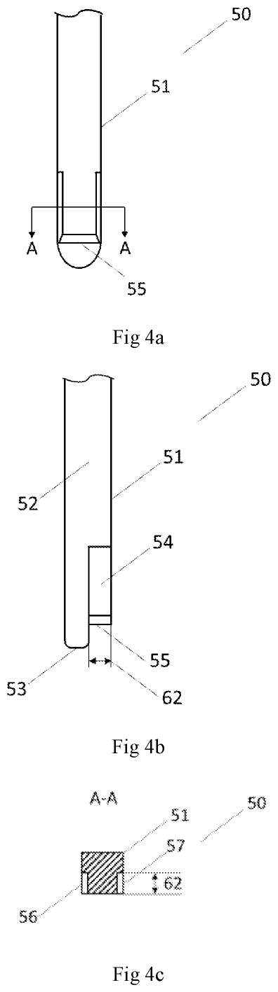

In a possible embodiment, as shown in FIGS. 4a-4c, the handle 51 of the gray hair removal cutter 50 comprises a main body 52 and an extended portion 53 extended from one end of the main body 52 along the first direction. The thickness of the extended portion 53 is less than that of the main body 52. An unoccupied portion 54 is formed between the extended portion 53 and the main body 52, and the blade 55 is located at the site of the unoccupied portion 54. The blade 55 extends from the extended portion 53 to the unoccupied portion 54, and the cutting edge is formed on the left and/or right edges 56 and/or 57 of the blade 55.

In a specific example, the sum of the thickness of the blade 55 and that of the extended portion 53 is equal to the thickness of the main body 52. In other words, the blade 55 retracts into the handle 51 in the front-back direction, and the blade 55 can be completely contained within the handle 51. As shown in FIG. 4a the handle 51 has through holes formed in the left and right directions, respectively. The left and/or right edges 56 and/or 57 at the bottom end of the blade 55 are sharpened, forming the cutting edges. In a specific example, the length 62 of the cutting edge is in the rang e of 10 μm to 10 mm. That is, the length 62 of the cutting edge is the thickness of the blade 55.

In another possible embodiment, the blade 55 further retracts into the handle 51 in the front-back direction until the blade 55 replaces the extended portion 53. In this case, the length 62 of the left and/or right edges (i.e., the cutting edges) of the bottom end of the blade 55 is equal to the length of the handle 51 in the front-back direction, i.e., the thickness of the handle 51. Therefore, the blade 55 is formed at the bottom end of the main body 52 of the handle 51, and the blade 55 is the bottom end of the whole gray hair removal cutter 50.

In a specific example, the edges of the left and right sides (i.e., the left and right edges 56 and 57) of the blade are unsharpened, or the edges of the left and right sides (i.e., the left and right edges 56 and 57) of the blade are made of soft materials. Thus the blade is a blunt blade, and the blunt blade can cooperate with the cutting edge on the blade of another gray hair removal cutter. In a specific example, if no blade is set at the bottom end of the main body 52, then the cutter is also a blunt cutter.

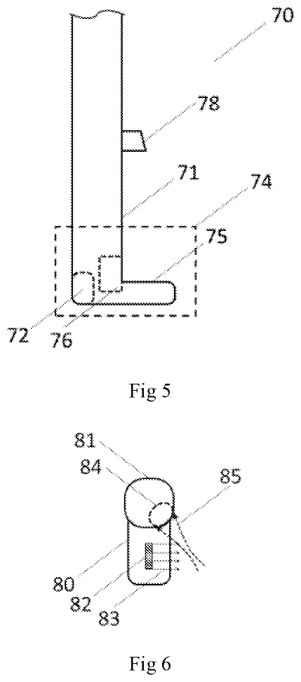

In one possible implementation, as shown in FIGS. 5-8, the cutter 70 further comprises a sensing unit 72, an identification unit, and a driving unit set on the handle 71. The sensing unit 72 responds to the contact of the end of the handle 71 with the scalp and outputs a start signal; the identification unit responds to the start signal to identify gray hair and outputs a removal signal; based on the removal signal, the driving unit drives the blade 75, causing the cutting edge to remove the identified gray hair.

In a specific example, the sensing unit 72 uses one or multiple of optical sensing, force sensing, electrical sensing, magnetic sensing, sound sensing, and thermal sensing to judge the contact of the handle with the scalp. By setting the sensing unit 72, it can be determined whether the gray hair removal cutter 70 is on the surface of the scalp, ensuring that the gray hair removal cutter 70 is on the surface of the scalp before removing gray hair, thereby ensuring that there is only one hair, or several hairs from the same hair follicle in the cutting zone, and avoiding any cutting when the gray hair removal cutter is not on the surface of the scalp. This is because when the gray hair removal cutter is not on the surface of the scalp, there are too many hairs, and the gray hair removal cutter cannot correctly identify gray hair and cannot work normally. Also, the gray hair removal cutter can be damaged easily when cutting a large number of hairs. In addition, when the gray hair removal cutter 70 is not on the surface of the scalp, the gray hair cannot be completely removed at the root, and such cutting is meaningless. Moreover, cutting at arbitrary heights will damage the user's hairstyle and affect the user's image. In a specific example, the sensing unit 72 is set at the bottom end of the handle 71. The function of the sensing unit is equivalent to a normally open switch. When the end of the handle contacts the scalp, the switch is closed to generate a start signal, which starts the identification unit and the blade 75.

In a specific example, the sensing unit 72 may be one or multiple of a touch switch, a pressure sensor, a thermal sensor, an infrared sensor, a resistance detector, a capacitive detector, an electromagnetic sensor, and an ultrasonic recognizer.

In a specific example, the identification unit comprises an optical source module providing identification light, an information acquisition module collecting optical information on the surface of the scalp, and an identification module analyzing the collected information to determine the presence of gray hair.

In a specific example, the information acquisition module is set in the end region 74 of the handle or connected to the blade 75. The light source module and identification module are set at the end of the handle 71 or the end away from the handle 71. In a further example, all modules of the identification unit are set inside the handle 71 or adhered to the handle 71 and/or the blade 75.

In a specific example, as shown in FIG. 6, the light source module 82 is set on the upper or lower surface of the blade 80 The light source module 82 can be a light emitting diode (LED) or an organic light emitting diode (OLED). The light path 83 generated by the light source module 82 may extend along the third direction (the left-right direction) to illuminate the hair to be cut, providing a low-background environment for the information acquisition module 84.

Correspondingly, the information acquisition module 84 is set at the end 81 of the handle or near the blade 80. In a specific example, the information acquisition module 84 has an optical focusing functionality. For example, the information acquisition module 84 may comprise a convex lens or a concave reflector to collect light 85 from the hair to be identified.

In a specific example, as shown in FIG. 5, the light source module 78 can be adhered to the handle 71. The light emitted by the light source module 78 extends in the first direction, illuminating from top to bottom the hair and scalp area at the bottom end of the handle 71 and on both sides of the blade 75, similarly providing a low-background environment of acquisition for the information acquisition module.

In a specific example, optical information on the scalp surface can be collected using techniques such as microscopy, confocal microscopy, and non-microscopy. The collected optical information may include one or more of transmitted spectra, absorbed spectra, reflected spectra, polarized spectra, or fluorescent spectra, and may also include image information with color and shape.

In a possible implementation, the driving unit is an electric drive or magnetic drive, such as an electrostatic drive, electromagnetic drive, piezoelectric drive, or inverse piezoelectric drive. The driving unit drives the blade, causing the cutting edge to cut the gray hair in the third direction (the left-right direction). Thus, what is cut is the hair in a rectangular zone. The length of the rectangle is equal to the length of the cutting edge.

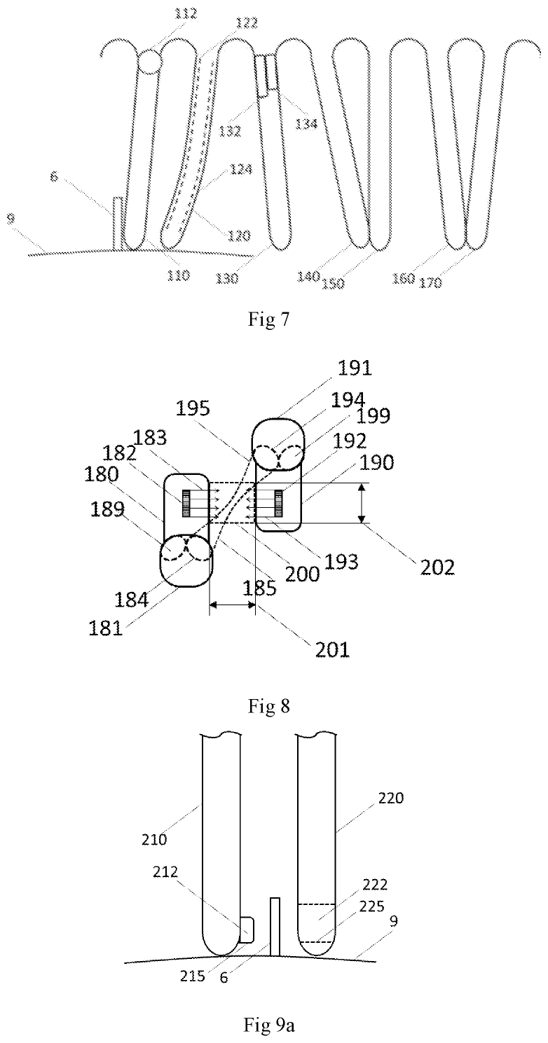

In a specific example, as shown in FIG. 7, the driving unit is an electromagnetic drive 112 set on the top end of the handle 110. The electromagnetic drive 112 drives the handle 110 to cut the gray hair 6 to the left or right in the third direction (the left-right direction). Since one end of the gray hair 6 is immobilized by the scalp 9, the fast-moving handle 110 drives the cutting edge on the blade to cut the gray hair on the scalp surface.

In a possible implementation, as shown in FIG. 7, the driving unit is an inverse piezoelectric drive. The inverse piezoelectric effect has the characteristics of rapid response speed (up to microseconds), high displacement accuracy, and long service life. In a specific example, the driving unit is a piezo bender actuator set inside the handle, and the gray hair removal cutter 120 is driven to cut to the left or right in the left-right direction by the piezo bender actuator. The piezo bender actuator comprises two electrodes 112 and 124 set inside the handle and a piezoelectric film between 122 and 124. By the voltage signal applied between the two electrodes 122 and 124, the piezo bender actuator drives the gray hair removal cutter 120 to cut gray hair to the left or right in the third direction (i.e., the left-right direction). The lengths of the two electrodes 122 and 124 of the piezo bender actuator, up to the maximum, can be as long as' the height of the handle, so that the entire handle can be bent. In another specific example, the driving unit is a stack multilayer piezo actuator located inside the handle. When the stack multilayer piezo actuator 132 extends or the stack multilayer piezo actuator 134 contracts, the gray hair removal cutter 130 cuts gray hair to the right or left in the left-right direction.

In a possible implementation, as shown in FIG. 5, the gray hair removal cutter 70 further comprises a signal transmitting/receiving unit. The unit is used to locate the coordinates of the end of the blade 75. In a specific example, the signal transmitting/receiving unit can be set on the blade 75, and the blade 75 can be used as a signal transmitting/receiving antenna. In other examples, a signal transmitting/receiving point 76 may also be separately set at the end of the handle 71 for positioning the end of the handle 71. For example, the signal transmitting/receiving point 76 is situated inside the handle 71 or adhered to the handle 71.

Another embodiment of the present invention provides a gray hair removal component comprising at least one gray hair removal cutter as described in the above embodiments. In this embodiment, the gray hair removal process can be achieved using only one gray hair removal cutter, making the gray hair removal component a single-cutter gray hair removal component. Since one end of the gray hair is immobilized by the scalp, a single rapidly moving gray hair removal cutter drives the cutting edge on the blade to cut the gray hair at a position very close to the scalp surface.

In a specific example, the gray hair removal component comprises one or two gray hair removal cutters, wherein at least one gray hair removal cut ter is driven by electromagnetic force or inverse piezoelectric force (such as the gray hair removal cutters 110, 120 and 130 in FIG. 7). Additionally, the gray hair removal component further comprises at least one sensing unit and al least one identification unit. The specific operation process of the gray hair removal component is as follows: the sensing unit responds to the contact between the end of any gray hair removal cutter in the gray hair removal component and the scalp surface, outputting a start signal. The identification unit responds to the start signal, and when any identification unit identifies gray hair, it outputs a removal signal. The driving unit, based on the removal signal, drives the gray hair removal cutter to cut the gray hair.

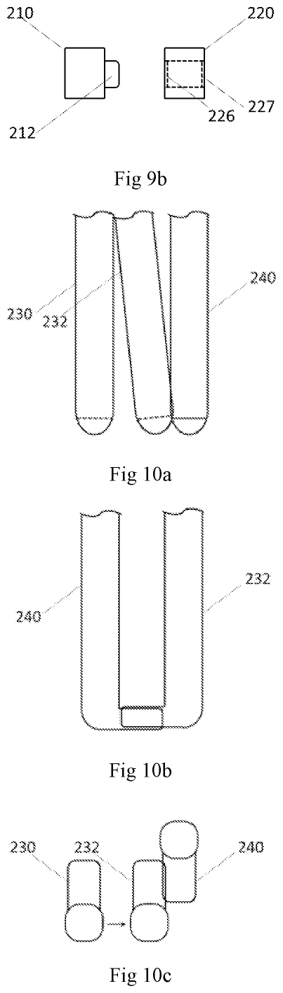

Another embodiment of the present invention provides a gray hair removal component, as shown in FIGS. 9-11, comprising multiple sets of combinations of the gray hair removal cutters arranged in parallel along the third direction. The gray hair removal component comprises a first gray hair removal cutter and a second gray hair removal cutter provided in the above embodiments, with the cutting edges of the first and second gray hair removal cutters arranged opposite each other. The first and second gray hair removal cutters can approach each other along the third direction to cut gray hair.

In a specific example, the first gray hair removal cutters and second gray hair removal cutters are arranged in a staggered manner. The opposite edges of both the first and second gray hair removal cutters are sharpened, allowing the cutting edges of the first gray hair removal cutters and the secondary hair removal cutters to remove along the third direction until they come into close contact with each other to cut gray hair. In another specific example, the first gray hair removal cutters and second gray hair removal cutters are arranged in a staggered manner. While the edges (such as the left or right edges) on the blades of the first gray hair removal cutters opposite to the second gray hair removal cutters are sharpened, forming the cutting edges, the edges on the blade of the second gray hair removal cutters opposite to the cutting edges of the first gray hair removal cutters are unsharpened, making the second gray hair removal cutters blunt cutters.

The gray hair removal process in this embodiment is achieved by the cooperation of two gray hair removal cutters each having opposite cutting edges, or by a gray hair removal cutter with a sharpened edge and a blunt cutter (i.e., a gray hair removal cutter where both the left and right edges of the blade are unsharpened, or only one edge is unsharpened, or both edges are made of soft material), making it a dual-cutter gray hair removal component.

It should be noted that the cutting area of the gray hair removal cutter, often referred to as the working microarea 200. As shown in FIG. 8, the size of the working microarea is typically determined by the length 202 of the engaged cutting edges and the distance 201 between the blades. In a specific example, the distance 201 between the blades of adjacent gray hair removal cutters is in the range of 10 μm to 10 mm. In a further example, the distance 201 between the blades of adjacent gray hair removal cutters is in the range of 90 μm to 3 mm. A smaller working microarea is advantageous for cutting individual gray hairs, while a larger working microarea can effectively improve the efficiency of gray hair cutting.

In a specific example, the gray hair removal component comprises at least two gray hair removal cutters: for instance, the blades of two gray hair removal cutters form the cutting edges; or the blade of one gray hair removal cutter is sharpened to form the cutting edge, while the other gray hair removal cutter is a blunt cutter. Among them, at least one gray hair removal cutter is driven by electromagnetic force or inverse piezoelectric force (such as the gray hair removal cutters 110, 120 and 130 in FIG. 7). Additionally, the component comprises at least one sensing unit, at least one identification unit, at least one driving unit, and at least one signal transmitting/receiving unit.

Specifically, the sensing unit responds to the contact between any gray hair removal cutter in the gray hair removal component and the scalp surface, outputting a start signal. The identification unit responds to the start signal, at least one identification unit identifies gray hair and outputs a removal signal. The driving unit, based on the removal signal, drives at least one gray hair removal cutter to move and cut gray hair. The signal transmitting/receiving unit locates the coordinates of the gray hair and emits the coordinates and the time of cutting the gray hair.

In a specific example, as shown in FIG. 7, the driving unit only drives the first gray hair removal cutter 140 to move its cutting edge to the right along the third direction, while the second gray hair removal cutter 150 remains stationary. The edge of the blade of the second gray hair removal cutter 150 opposite to the cutting edge of the first gray hair removal cutter 140 can be either sharpened or left blunt. In another specific example, the driving unit simultaneously drives the first gray hair removal cutter 160 and the second gray hair removal cutter 170 to move in opposite directions along the third direction, thereby cutting the gray hair. While cutting the gray hair, the signal transmitting/receiving unit locates the coordinates of the gray hair in real-time and then emits the information of the time and location of cutting the gray hair.

In a possible implementation, the gray hair removal component comprises multiple sets of the combinations of the gray hair removal cutters arranged in parallel along the third direction. As shown in FIG. 8, the combination of the gray hair removal cutters comprises the first gray hair removal cutter, the second gray hair removal cutter, and the first light source module 182 and the second light source module 192 located on the blades of the two gray hair removal cutters. The first light source module 182 is set on the upper or lower surface of the blade 180 of the first gray hair removal cutter, and the second light source module 192 is set on the upper or lower surface of the blade 190 of the second gray hair removal cutter. The light 183 generated by the first light source module 182 is illuminated to the right along the third direction, and the light 193 generated by the second light source module 192 is illuminated to the left along the third direction. In addition, it also comprises the first information collection module 184 set at the handle end 181 of the first gray hair removal cutter and the second information collection module 194 set at the handle end 191 of the second gray hair removal cutter. The collection zones of the first information collection module 184 and the second information collection module 194 are the zones illuminated by the first light source module 182 and the second light source module 192, and the directions of collection of the first information collection module 184 and the second information collection module 194 are set diagonally. The first information collection module 184 and the second information collection module 194 have optical focusing functionality, such as through convex lenses or concave reflectors, used to collect light 185 and 195 from hair, respectively. By setting the first information collection module 184 and the second information collection module 194, the efficiency of collecting optical information from gray hair is improved. If the optical information about gray hair collected by either the first information collection module 184 or the second information collection module 194 is identified as gray hair by the identification module, then a removal signal is outputted. This prevents any interference from nearby colored hairs that would block and affect the identification of gray hair. Considering that two or more hairs cannot maintain a fixed relative position along the vertical direction, meaning that gray hair cannot be completely blocked by colored hair, the structure of this implementation ensures accurate collection of optical information from all gray hair. In another specific example, it also comprises the third information collection module on the blade of the first gray hair removal cutter and the fourth information collection module on the blade of the second gray hair removal cutter. If the optical information collected by any one of the information collection modules is identified as gray hair by the identification module, it outputs a removal signal.

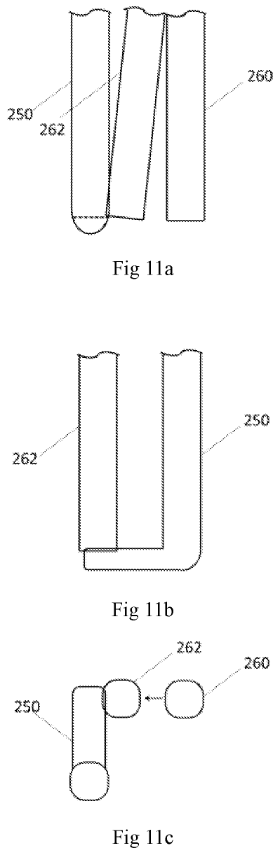

In a possible implementation, as shown in FIGS. 10a-10c, the first gray hair removal cutter 230 and the second gray hair removal cutter 240 are arranged in a staggered manner. In the second direction, the handle of the first gray hair removal cutter 230 is located in front of the handle of the second gray hair removal cutter 240. The blade of the first gray hair removal cutter 230 and that of the second gray hair removal cutter 240 are formed by extending outward from their respective side walls of the handles along the second direction. The blades of the first gray hair removal cutter 230 and the second gray hair removal cutter 240 are centrosymmetrically arranged. For example, the blade of the first gray hair removal cutter 230 extends backward from the side wall of the handle, and the blade of the second gray hair removal cutter 240 extends forward from the side wall of the handle. From the view of the third direction, the blades of the first gray hair removal cutter 230 and the second gray hair removal cutter 240 overlap. The edge of the blade of the first gray hair removal cutter 230 opposite to the blade of the second gray hair removal cutter 240 and/or the edge of the blade of the second gray hair removal cutter 240 opposite to the blade of the first gray hair removal cutter 230 form the cutting edges. In a specific example, the edge (such as the left or right edge) of the blade of the first gray hair removal cutter 230 opposite to the blade of the second gray hair removal cutter 240 is sharpened, forming a cutting edge, with the structure as shown in FIG. 1. The edge (such as the left or right edge) of the blade of the second gray hair removal cutter 240 opposite to the cutting edge of the first gray hair removal cutter 230 may be sharpened, or not (i.e., the second gray hair removal cutter is a blunt cutter).

In this implementation, when removing gray hair, the first gray hair removal cutter 230 can be driven to move along the third direction to the position 232 as shown in FIG. 10a, while the second gray hair removal cutter 240 remains stationary. This causes the cutting edge of the first gray hair removal cutter 230 to come into contact with the side edge of the blade of the second gray hair removal cutter 240 to cut the gray hair. Alternatively, the second gray hair removal cutter 240 can be driven to move towards the first gray hair removal cutter 230 along the third direction, or both the first gray hair removal cutter 230 and the second gray hair removal cutter 240 can be simultaneously driven to move towards each other to cut the gray hair. In this implementation, even when the two gray hair removal cutters are closed to remove gray hair, there is still a significant space between the handles of the first gray hair removal cutter 230 and the second gray hair removal cutter 240, and the hairs in between do not hinder the cutting of gray hair.

In a possible embodiment, as shown in FIGS. 9a-9b or FIGS. 11a-11c, the handle of the second gray hair removal cutter comprises a main body and an extended portion extending from one end of the main body along the first direction. The thickness of the extended portion is smaller than the thickness of the main body. The extended portion and the main body form an unoccupied portion therebetween. The blade of the second gray hair removal cutter is located at the site of the unoccupied portion, and extends from the extended portion towards the unoccupied portion. The cutting edge is formed on the bottom edge of the blade of the second gray hair removal cutter opposite to the blade of the first gray hair removal cutter.

In a specific example, as shown in FIGS. 9a-9b, the sum of the thickness of the blade and that of the extended portion of the second gray hair removal cutter 220 equals the thickness of the main body. The blade is retracted into the handle in the front-back direction. The handle has a through hole 222 in the left-right direction. The bottom end 225 of the hole 222 of the second gray hair removal cutter 220 is sharpened to form a cutting edge 226 (cutting edges 226 and 227 if both sides are sharpened), and it is arranged opposite to the blade 212 of the first gray hair removal cutter 210.

In another specific example, as shown in FIGS. 11a-11c, the blade of the second gray hair removal cutter 260 is formed at the bottom end of the main body of the handle. That is, the blade is the bottom end of the second gray hair removal cutter 260. The length of the left and/or right edges (i.e., cutting edges) of the bottom end of the blade of the second gray hair removal cutter 260 is the length of the handle in the front-back direction, i.e., the thickness of the handle.

In a possible embodiment, as shown in FIGS. 9a-9b, the first gray hair removal cutter 210 is a blunt cutter. The blunt blade 212 of the first gray hair removal cutter 210 extends outward from one side wall of the handle along the third direction. The bottom surface 215 of the blunt blade 212 of the first gray hair removal cutter 210 is arranged opposite to the cutting edge 226 of the bottom end 225 of the blade of the second gray hair removal cutter 220. That is, the bottom surface 215 of the blunt blade 212 of the first gray hair removal cutter 210 and the cutting surface 225 of the second gray hair removal cutter 220 share the same plane. When cutting the gray hair 6 that is immobilized on the scalp 9, by driving the first gray hair removal cutter 210 toward the second gray hair removal cutter 220 or simultaneously driving the first gray hair removal cutter 210 and the second gray hair removal cutter 220 toward each other, the bottom surface 215 of the blunt blade 212 of the first gray hair removal cutter 210 cooperates with the left cutting edge 226 of the bottom end surface 225 of the blade of the second gray hair removal cutter 220 to cut the gray hair 6. Because the first gray hair removal cutter 210 is set to be a blunt cutter, the hair passing through the cutters 210 and 220 will not be damaged, ensuring the quality of the user's hair.

In one possible embodiment, as shown in FIGS. 11a-11c, the blade of the first gray hair removal cutter 250 extends outward from one side wall of the handle along the second direction. The top surface of the blade of the first gray hair removal cutter 250 is arranged opposite to the cutting edge of the bottom surface of the second gray hair removal cutter 260. That is, the top surface of the blade of the first gray hair removal cutter 250 and the bottom end surface (i.e., cutting surface) of the second gray hair removal cutter 260 are in the same plane. In a specific example, the distance in the third direction between the cutting edges of the first gray hair removal cutter 250 and the second gray hair removal cutter 260 is in the range of 10 μm to 10 mm. In a further preferred example, the distance is in the range of 90 μm to 3 mm.

When cutting gray hair, by driving the first gray hair removal cutter 250 to the second gray hair removal cutter 260, or the second gray hair removal cutter 260 to the position 262 to close with the first gray hair removal cutter 250, or simultaneously driving the first gray hair removal cutter 250 and the second gray hair removal cutter 260 toward each other, the left or right edge of the top surface of the blade of the first gray hair removal cutter 250 cooperates with the cutting edge of the bottom end of the second gray hair removal cutter 260 to cut the gray hair. In a specific example, the left and right edges of the top surface of the blade of the first gray hair removal cutter 250 are sharpened, while the bottom surface of the second gray hair removal cutter 260 may not be sharpened. In another specific example, the left and right edges of the top surface of the blade of the first gray hair removal cutter 250 are unsharpened, then the bottom surface of the second gray hair removal cutter 260 must be sharpened. This implementation ensures that there is always a sufficiently large gap between the handle of the first gray hair removal cutter 250 and the handle of the second gray hair removal cutter 260, so that the hair between the first gray hair removal cutter 250 and the second gray hair removal cutter 260 does not affect the cutting of gray hair.

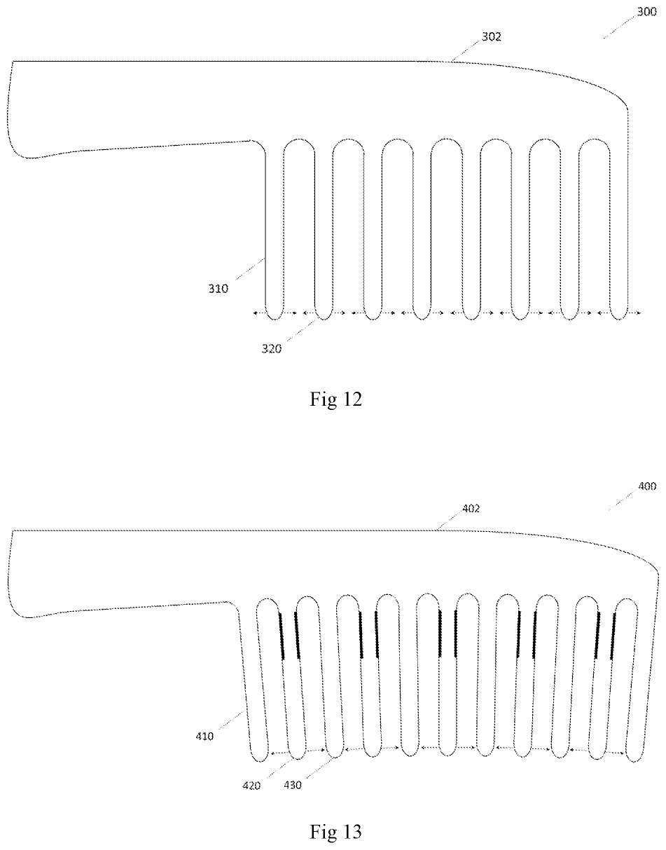

In another embodiment of the present invention, a gray hair removal comb 300 is provided, as shown in FIG. 12, comprising a comb body 302 and at least one gray hair removal component as described in the embodiments above. The gray hair removal component is a single-cutter gray hair removal component, i.e., comb tooth 310. In this embodiment, multiple comb teeth 310 (gray hair removal cutters) are arranged in parallel along the third direction.

The process of using the gray hair removal comb 300 in this embodiment is as follows: the combing direction of the gray hair removal comb 300 is the second direction, i.e., combing on the surface of the user's scalp along the front-back direction, and the combing direction is perpendicular to the comb body 302 (i.e., the direction of arranging the comb teeth 310). At the same time, the cutting direction of the comb teeth 310 or the gray hair removal cutters is in the left-right direction. That is, the gray hair removal comb 300 combs along the front-back direction, while the single-cutter gray hair removal components move in the left-right direction to cut gray hair. In a specific example, the distance between adjacent comb teeth 310 and 320 (i.e., gray hair removal cutters) typically does not exceed 10 mm.

In another embodiment of the present invention, a gray hair removal comb 400 is provided, as shown in FIG. 13, comprising a comb body 402 and at least one gray hair removal component as described in the embodiments above. In this embodiment, the gray hair removal component is a dual-cutter gray hair removal component, and adjacent comb teeth such as 410 and 420 cooperate to achieve gray hair cutting. Multiple comb teeth such as 410 and 420 (i.e., gray hair removal cutters) in this embodiment are arranged in a staggered (front and back) manner, so that when adjacent gray hair removal cutters are closed, there is still enough space between the handles of adjacent gray hair removal cutters, preventing the hair located therein from affecting the cutting of gray hair. The orientations of the blades of adjacent gray hair removal cutters may be forward or backward. The order of arrangement can be such that the blade of the first gray hair removal cutter extends backward, the blade of the second gray hair removal cutter extends forward, and so on, allowing the blades of the first and second gray hair removal cutters to come close to each other when closed. The arrangement of adjacent gray hair removal cutters can also be such that the blade of the first gray hair removal cutter faces backward, the blade of the second gray hair removal cutter is its bottom end (or the blade is retracted into the handle), the blade of the third gray hair removal cutter faces backward, the blade of the fourth gray hair removal cutter is its bottom end, and so on, so that the blades of adjacent gray hair removal cutters can come close to each other when closed.

In a specific example, the gray hair removal comb 400 comprises a comb body 402 and at least one gray hair removal component. The gray hair removal component comprises the first gray hair removal cutter and the second gray hair removal cutter, where the first gray hair removal cutter (comb tooth 410) remains stationary, and the second gray hair removal cutter (comb tooth 420) is driven by a piezoelectric actuator for cutting in the left-right direction. Additionally, it may comprise a third gray hair removal cutter (comb tooth 430). The second gray hair removal cutter (comb tooth 420) and the third gray hair removal cutter (comb tooth 430) together form another dual-cutter gray hair removal component. In a specific example, the distance between adjacent gray hair removal cutters (such as comb teeth 410 and 420) is in the range of 10 μm to 10 mm. In a further example, the distance between adjacent gray hair removal cutters (such as comb teeth 410 and 420) is in the range of 90 μm to 3 mm.

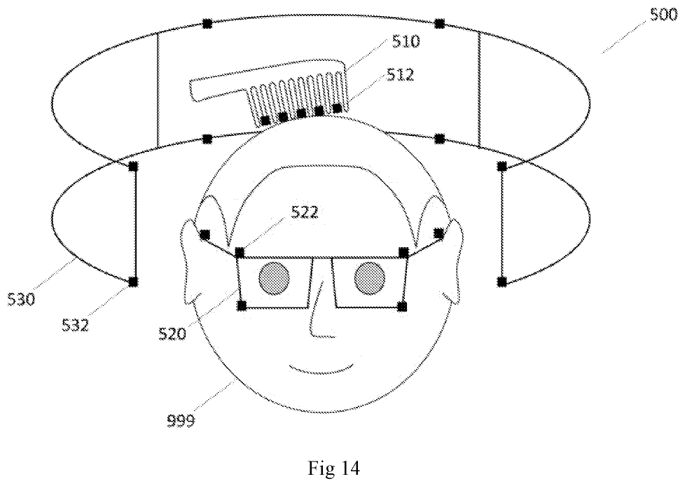

In one embodiment of the present invention, a gray hair removal system 500 is provided, as shown in FIG. 14, comprising a gray hair removal comb as provided in the embodiments above or a gray hair removal comb as provided in another embodiment above.

In one possible implementation, the gray hair removal system comprises a recording module for recording and storing the real-time length of each gray hair of the user. In a specific example, as shown in FIG. 14, the gray hair removal system comprises a gray hair removal comb 510 and a recording module. The recording module, for example, can be an application software package stored in the user's personal electronic devices, such as a mobile phone, computer, or tablet. The application software package comprises a scalp coordinate package, a gray hair root package, and a real-time gray hair length package. Specifically, the scalp coordinate package is used to record and store the user's scalp coordinates, which are collected and transmitted to the package by a sensing unit when in contact with the scalp surface. The gray hair root coordinate package records the coordinates of each gray hair of the user. The identification unit, upon identifying the gray hair, combining with the signal transmitting/receiving unit, records positional information and transmits it to the package. The real-time gray hair length package is used to record the coordinates and time when the user cuts the gray hair. When a gray hair removal cutter cuts the gray hair, the signal transmitting/receiving unit records the positional information and transmits it to the package. Based on the coordinates and time of cutting the gray hair, the package provides a distribution map of the user's gray hairs and real-time length data for each gray hair. This enables the user, according to the provided gray hair map, to view the distribution and real-time length of gray hair on their personal electronic devices at any time, and to remove gray hair as needed.

In a specific example, since the growth rate of hair is approximately 0.4 mm per day, the length (l) of each gray hair on the user's head can be calculated using the following formula:

$$l = 0.4 ( t - {t}_{1} )$$

where t is the time when the user views the software package, and t₁ the time of the last removal of this gray hair.

In a possible implementation, the gray hair removal system also comprises a signal locator 520, which compensates for the movement of the user's head during the process of cutting gray hair. Specifically, the signal locator comprises at least three signal transmitting/receiving points that can be immobilized in the region below the user's hair and above the chin. In a specific example, the signal locator 520 is a pair of glasses or a glasses frame, with multiple signal transmitting/receiving points 522. The communication between the signal transmitting/receiving unit 512 on the gray hair removal cutter, gray hair removal component, or gray hair removal comb, and the signal transmitting/receiving points 522 on the signal locator is realized by using electromagnetic waves or light signals. The position data of the signal transmitting/receiving points 512 on the gray hair removal cutter, gray hair removal component, or gray hair removal comb are determined based on the direction, intensity, and phase of the electromagnetic waves or light.

In another possible implementation, the gray hair removal system also comprises a signal base 530. The signal base 530 can be fixed in a stationary position, such as on a wall, floor, or ceiling, etc.

In a specific example, as shown in FIG. 14, the signal locator 520 is a pair of glasses or a glasses frame 520 with multiple signal transmitting/receiving points 522. The signal base 530 is a rigid frame 530 set around the user's head 999, with multiple signal transmitting/receiving points 532.

In a specific example, the communication among the signal transmitting/receiving unit 512 on the gray hair removal comb 510 on the gray hair removal cutter, gray hair removal component, or gray hair removal comb, the signal transmitting/receiving points 522 on the signal locator 520, and the signal transmitting/receiving points 532 on the signal base 530 is realized using electromagnetic waves or light signals. The positions of the signal transmitting/receiving points 512 on the gray hair removal cutter, gray hair removal component, or gray hair removal comb are determined based on the direction, intensity, and phase of the electromagnetic waves or light.

In a specific example, three different methods can be used to calculate the coordinates of the end of the gray hair removal cutter and obtain the coordinates of the roots of hairs on the scalp:

1. The user wears the signal locator 520. The signal 512 from the end of the gray hair removal cutter is compared with the signal from the signal locator 520 to obtain the coordinates {X, Y, Z} of the root relative to the signal locator 520. Scan the scalp to generate a root coordinate map for the user.

Each time during use, the user does not need to wear the signal locator 520. The positioning is realized by the relative positions of the local roots in the root coordinate map.

2. The user wears the signal locator 520. The signal 512 from the end of the gray hair removal cutter is compared with the signal from the signal locator 520 to obtain the positions of several features on the scalp, such as the root coordinates at the hairline, etc.

Each time during use, the user wears the signal locator 520. Using the positions of the features, the relative position between the signal locator 520 and the hair roots can be calibrated. By comparing the signal 512 from the end of the gray hair removal cutter with the signal from the signal locator 520, the real-time root coordinates {X, Y, Z} are determined. The relative position of the signal locator 520 to the scalp is fixed, so the movement of the user's head during the process of cutting gray hair does not affect the positioning of the roots.

3. By comparing the signal from the end of the gray hair removal cutter with the signal from the signal base 530, the uncorrected coordinates {X, Y, Z} of the roots are obtained. These uncorrected coordinates change due to the movement of the user's head during the process of cutting gray hair. The user wears the signal locator 520. The real-time change in the coordinates of the signal locator 520 is obtained by comparing the signal from the signal locator 520 with the signal from the signal base 530. Based on the relative positions of the scalp and the signal locator 520 to the signal base 530, the real-time change is converted into a real-time correction {ΔX, ΔY, ΔZ} for the roots. Thus the corrected root coordinates are obtained: {X_{R}, Y_{R}, Z_{R}}={X, Y, Z}+{ΔX, ΔY, ΔZ}. Similarly, the corrected coordinates {X_{R}, Y_{R}, Z_{R}} do not change due to the movement of the user's head during the process of cutting gray hair.

In the embodiments of the present invention, the gray hair removal cutter, gray hair removal component, gray hair removal comb, and gray hair removal system, compared to existing gray hair removal methods, do not produce any gases during the process of cutting gray hair, thus avoiding indoor air pollution.

Obviously, the above embodiments of the present invention are only examples to illustrate the invention and are not intended to limit the implementation of the invention. Those skilled in the art in the relevant field can make other changes or modifications based on the above description. It is impossible to exhaustively list all embodiments here. Obvious variations or modifications derived from the technical solutions of the present invention are still within the scope of protection of the present invention.

1. A gray hair removal cutter, comprising:
a handle and a blade located on the handle;
defining that extension direction of the handle is a first direction, a direction perpendicular to the first direction is a second direction, and a direction perpendicular to both the first and second directions is a third direction;
wherein a single edge or two opposite edges of the blade comprise a cutting edge that is used for removing gray hair along the third direction, and the cutting edge extends along the second direction.

2. The cutter according to claim 1, wherein the blade is formed by extending outward from a side wall of the handle along the second direction.

3. The cutter according to claim 2, wherein an end of the blade away from the handle forms a cone or blunt cone.

4. The cutter according to claim 3, wherein:
two opposite sides of the blade arranged along the third direction incline inward and form a curved surface that is recessed inward in middle; and
the cutting edge is formed on at least one edge of the curved surface.

5. The cutter according to claim 1, wherein:
the handle comprises an extended segment that is formed by extending from a side wall of the handle along the second direction, and the blade is located at an end of the extended segment that is away from the handle; and
the cross-sections of the extended segment and the blade in the third direction are conical or parabolic.

6. The cutter according to claim 1, wherein:
the handle comprises a main body and an extended portion that is formed by extending from one end of the main body along the first direction, and the thickness of the extended portion is less than the thickness of the main body;
the extended portion and the main body form an unoccupied portion therebetween, and the blade is located at the unoccupied portion;
the blade is formed by extending from the extended portion towards the unoccupied portion; and
the cutting edge is formed on either a single edge or two opposite edges of the end of the blade that is away from the main body.

7. The cutter according to claim 1, wherein:
the cutter further comprises an identification unit, a sensing unit, and a driving unit set in the handle;
the sensing unit responds to contact of the end of the handle and a scalp, and outputs a start signal;
the identification unit responds to the start signal, identifies gray hair, and outputs a removal signal; and
based on the removal signal, the driving unit drives the blade to move, causing the cutting edge to remove the identified gray hair.

8. The cutter according to claim 7, wherein:
the driving unit is at least one of an electrostatic actuator, an electromagnetic actuator, a piezoelectric actuator, or a reverse piezoelectric actuator.

9. A gray hair removal assembly, wherein the assembly comprises at least one gray hair removal cutter according to claim 1.

10. The assembly according to claim 9, wherein:
the assembly comprises a first gray hair removal cutter and a second gray hair removal cutter, arranged opposite each other;
the cutting edge of the first gray hair removal cutter and the cutting edge of the second gray hair removal cutter are arranged opposite each other; and
the first gray hair removal cutter and the second gray hair removal cutter can approach each other along the third direction to cut gray hair.

11. The assembly according to claim 10, wherein:
the blade of the first gray hair removal cutter and the blade of the second gray hair removal cutter are formed by extending outward from their respective handle side walls along the second direction;
the blade of the first gray hair removal cutter and the blade of the second gray hair removal cutter are centrosymmetrically arranged; and
the cutting edges are formed on an edge of the blade of the first gray hair removal cutter that is opposite to the blade of the second gray hair removal cutter, and/or on an edge of the blade of the second gray hair removal cutter that is opposite to the blade of the first gray hair removal cutter.

12. The assembly according to claim 10, wherein:
the handle of the second gray hair removal cutter comprises a main body and an extended portion that is formed by extending from one end of the main body along the first direction, and the thickness of the extended portion is less than the thickness of the main body;
the extended portion and the main body form an unoccupied portion therebetween, and the blade of the second gray hair removal cutter is located at the unoccupied portion;
the blade of the second gray hair removal cutter is formed by extending from the extended portion towards the unoccupied portion; and
the cutting edge of the second gray hair removal cutter is formed on a bottom edge of the blade of the second gray hair removal cutter that is opposite to the blade of the first gray hair removal cutter.

13. The assembly according to claim 10, wherein:
the blade of the first gray hair removal cutter is formed by extending outward from one side wall of the handle along the third direction; and
a bottom surface of the blade of the first gray hair removal cutter and the cutting edge of the second gray hair removal cutter are arranged opposite each other.

14. The assembly according to claim 10, wherein:
the blade of the first gray hair removal cutter is formed by extending outward from one side wall of the handle along the second direction; and
a top surface of the blade of the first gray hair removal cutter and the cutting edge of the second gray hair removal cutter are arranged opposite each other.

15. A grey hair removal comb, comprising a comb body and at least one gray hair removal assembly according to claim 9.

16. (canceled)

17. A gray hair removal system comprising the gray hair removal comb according to claim 15.

18. A gray hair removal system according to claim 17, wherein the system comprises a recording module for recording and storing a real-time length of each gray hair of a user.
